(19) United States
(12) Patent Application Publication
(10) Pub. No.: US 2006/0080406 A1
(43) Pub. Date: Apr. 13, 2006

(54) XWindows++

(76) Inventor: Boris Sacks, Caracas (VE)

Correspondence Address: BORIS SACKS;C/O BERTA BEHMOIRAS, APT. 21C, 5660 COLLINS AVE., MIAMI BEACH, FL, 33140, US

(21) Appl. No.: 10/921,941

(22) Filed: Aug. 20, 2004

(51) Int. Cl. G06F 15/16

(52) U.S. Cl. 709/218

(57) ABSTRACT

The invention is a programming functionality extension to any protocol for the implementation of network-based windows systems (e.g., The X-Protocol), that allows an independent requirement in hardware and software between the computer that runs the application and the computer that displays the graphic output of that application.

### BACKGROUND OF INVENTION

1. Field of Invention

The present invention relates to the field of information services, more specifically to a programming functionality extension of the X windows system in the X client and X server. This functionality allows the X sever to generate a graphic output of the program running in a remote computer with X client, that couldn't be possible to visualize in the graphic display in the computer running the X client, because that computer doesn't meet the needed hardware or software requirements to display it This extension to the X windows system is not currently supported by the client-server interaction in the core protocols.

The X windows system is not strictly a UNIX family operating system phenomenon. It is a standard for the implementation of network-based windows systems, and there is not direct dependence on UNIX base operating system (e.g., Linux) in its protocol. This emphasis on system independence carries through to the server, to which the number of server ports attests.

Through this invention explanation, we will refer to Xclient++ as the correspondent X client with our added functionality extension, and the Xserver++ as the correspondent X server with our added functionality extension. The Xwindows++ is an extension to the X windows system that allows the display of the video output from a remote computer with Xclient++ using the graphic device of the Xserver++, with any electronic communication medium that support it.

2. Discussion of Prior Art

A lot of people have personal computers in their homes and business, but they have to make upgrades to software and hardware and sometimes after a few months the computer they just bought becomes obsolete, due to the change in software and the newer hardware requirements. Beyond of that the capacity of the graphical display is crucial for personal and business interest The X windows system has been reliable for almost 30 years, and can be modified to create a new way to access better graphical applications from electronic graphic displays that are remotely connected, without the need of increasing the hardware requirements and software modifications in the computer that runs an application, due to the modifications just extending the functionality of the X window system using the XWindows++. This extension to the X client and X server allows the display of graphical output that couldn't be possible in the local computer that runs the program, but allows displaying the graphical output in the remote graphical display device that has a connection to this local computer.

### OBJECTS AND ADVANTAGES

Several objects and advantages of the invention are:

(a) To reduce the cost of graphic hardware accelerators installed only in computers with Xserver++. The computers with Xclient++ doesn't need the graphic hardware accelerators only the user end client computers with the Xserver++ need these, the users are connected remotely to the remote server machine and they don't use it for graphical output. This dependency of the video card will be only necessary on the user end in this situation. The remote driver feature allows equipments to have just a basic operating system with Xserver++, that permits a remote hardware to be used as an output device with a connection to a remote computer with Xclient++, and work just as a peripheral device of the computer.

b) To develop electronic device's Xserver++s that can be transparent to the program running in the remote server with Xclient++ establishing a direct communication with the hardware. This direct access of the program to the hardware of the electronic equipment, is not allowed in most operating systems, but can be implemented in the device's Xserver++ located in the end user that runs in a different configurations.

(c) To use any set of application programming interface to display graphics that the remote computer operating system running the Xclient++ doesn't support but the program can use because its supported by the operating system that is running the Xserver++ on the end user equipment. For example almost all graphics programming in a Unix remote server with Xprotocol uses XLIB library to develop the graphical user interface, but with the use of this invention the users display will be able to display graphics that the original server configuration couldn't display, the program can use DirectX library from Microsoft to display graphics in a Windows operating system that use an Xserver++ with this feature. This can be used to give even more facilities like the provision of sound due to the use of programming facilities that doesn't need to be implemented on the remote computer.

(d) To develop multiplayer applications and videoconferences within a remote server, that can manage the connection to multiple and different graphical outputs simultaneously to multiple Xserver++ from end users. This can create an optimal visual experience to the end user and increase transmission speeds.

(e) To develop video output for small devices where the graphical information targets directly the small device hardware and software characteristics, giving a faster communication response. For example the phone screen can be used as an extension of the remote computer, using the Xserver++ to facilitate in the phone direct access to the video chips without the need to be processed by the operating system of the phone.

(f) To develop video output for high definition devices where the graphical information targets directly the high definition graphical displays and software characteristics, giving a faster communication response. For example the high definition television can be used as an extension of the remote computer, using the Xserver to facilitate in the high definition television direct access to the video chips without the need to be processed by the operating system of the high definition television.

### SUMMARY

The invention is a programming functionality extension of the X Windows systems, that overcomes hardware and software limitations, by giving access to hardware and software located in the output device's X server with a functionality extension, and an remote computer's X client with a functionality extension, that doesn't have the requirements to produce the output generated by the program in the local computer with Xclient++, but the output device connected to the remote computer with Xserver++ has.

### DRAWING—FIGURES

FIG. 1 illustrates a personal computer running an Xserver++ by an end user that it's configured with a different graphical hardware configuration to the remote computer with Xclient++, which are connected.

FIG. 2 illustrates a personal computer running an Xserver++ by an end user that it's configured with any application programming interface that it's not supported by the remote server running Xclient++, which are connected.

FIG. 3 illustrates a personal computer running an Xserver++ by an end user with a operating system that allows a direct interaction between the Xserver++ and its computer hardware, this direct interaction is not allowed in the operating system running in the remote computer with Xclient++, which are connected.

### DRAWING—LIST OF REFERENCE NUMERALS

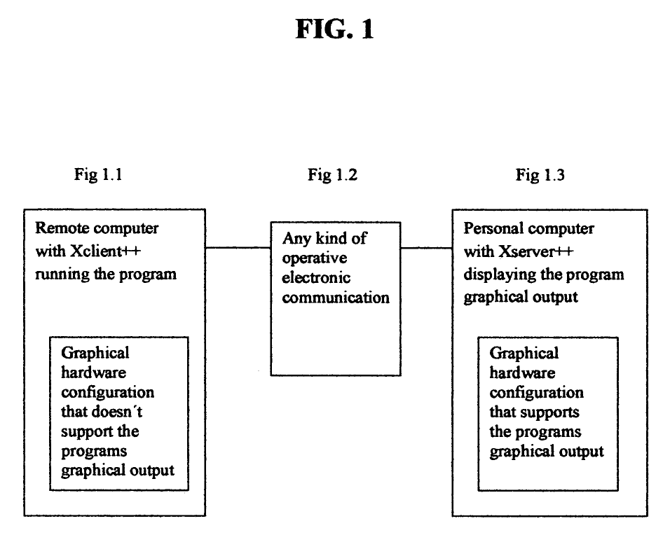

FIG. 1 illustrates a personal computer running an Xserver++ by an end user that it's configured with a different graphical hardware configuration to the remote computer with Xclient++, which are connected.

FIG. 1.1 Remote computers with Xclient++ running the program

FIG. 1.2 Any kind of operative electronic communication

FIG. 1.3 Personal computer with Xserver++ displaying the program graphical output

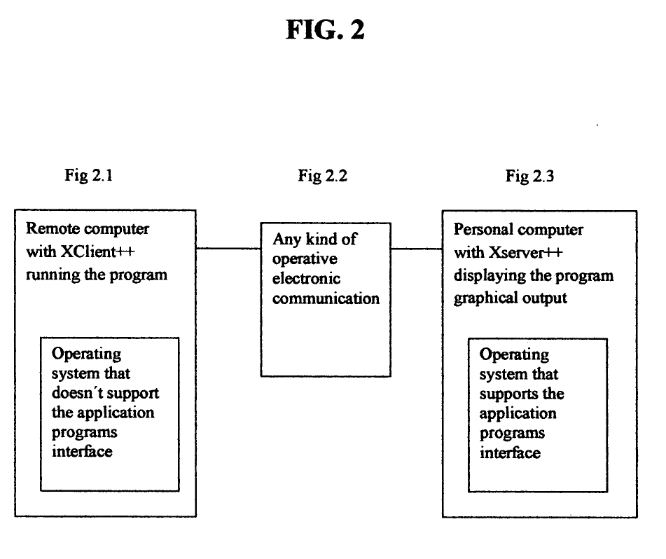

FIG. 2 illustrates a personal computer running an Xserver++ by an end user that it's configured with any application programming interface that it's not supported by the remote server running Xclient++, which are connected.

FIG. 2.1 Remote computers with Xclient++ running the program

FIG. 2.2 Any kind of operative electronic communication

FIG. 2.3 Personal computer with Xserver++ displaying the program graphical output

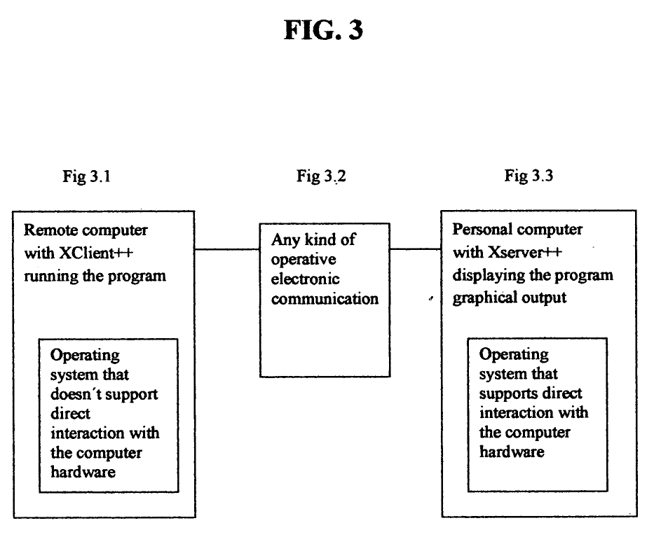

FIG. 3 illustrates a personal computer running an Xserver++ by an end user with a operating system that allows a direct interaction between the Xserver++ and its computer hardware, this direct interaction is not allowed in the operating system running in the remote computer with Xclient++, which are connected.

FIG. 3.1 Remote computers with Xclient++ running the program

FIG. 3.2 Any kind of operative electronic communication

FIG. 3.3 Personal computer with Xserver++ displaying the program graphical output

### DETAILED DESCRIPTION

This invention enhances the graphic output capabilities trough an extension to the X windows system. This functionality extension is applied to the X client and X server. This extension gives the ability to the electronic device running the X server to display graphical outputs from the program running in the remote computer with the X client, that couldn't be achieved due to limitations in hardware and software requirements.

The programs can use application programming interface that are not supported in the computer that its application is running and can directly access hardware in the electronic device of the end user due to this Xwindows++ extension supported in the X windows system.

### OPERATION OF INVENTION

In operation the electronic device with Xserver++ in the remote computer allows the end user to cost to their Xclient++ in the remote server and have graphic display output that are proper to the graphics facilities of the electronic device running the Xserver++, giving a complete independence of the facilities of the remote server running the Xclient++.

The programming functionality extension doesn't have specific implementation requirements, to support a wide extension of operating systems and hardware used in electronic devices running the Xserver and Xclient++.

### DESCRIPTION AND OPERATION OF ALTERNATIVE EMBODIMENTS

Access for electronic devices running the Xserver++ to use any graphics hardware and application programming interface implemented in the server, and avoiding limitations of the direct access to the hardware running the Xserver++ user end. Requirement constrains about how much hardware is necessary to run a specific program in the remote server are not a concern because the remote server is used only to run the program, not to display the program's graphical output.

### CONCLUSION RAMIFICATIONS AND SCOPE OF INVENTION

While my above description contains much specificity this should not constitute as limitations on the scope of the invention, but rather as exemplification of one preferred embodiments thereof. Many other variations are possible. For example:

The remote computer can be any computer with and Xclient++ that have at least a connection to the graphical display device with an Xserver++.

The remote server with Xclient++ can have specialized software to run processes as complicated as necessary to create a graphical output like architectural, mechanical, computer animations, mathematical, etc. by providing the graphical display output to a graphical display device with Xserver++ that just shows the graphical output This independence between processes can expand the opportunities for renting the use of remote computers and run remote programs that couldn't be afforded by small business or personal users, but as sharing resources they could afford them.

The programming functionality extension can be used to create a bridge between UNIX base operating systems computers and Windows operating system computers. For example, DirectX is a collection of proprietary multimedia application programming intewrice, this functionality can be used to allow programs running in UNIX base operating systems computers with the Xclient++ to call this DirectX directly through the Xserver in Windows operating system computers. This is an exemplification that any application programming interface that is not implemented in any operating system could be used.

What is claimed is:

1. The invention is a programming functionality extension to overcome hardware and software limitation by the x windows system, comprising the following:
a) an electronic graphic device with an x server with the functionality extension added
b) a remote computer with any operating system that allows running any program that can use the x client with the functionality extension added
c) an operative connection between said remote computer running programs that uses the x client with the functionality extension added and electronic graphic device with an x server with the functionality extension added.

2. A x windows system with an x server and a x client both with the functionality extension added that gives at least one of the following requirements:
a) direct communication of the program running in the remote server with x client to the graphics hardware of the device running the electronic graphic device with the x server, through any electronic medium connection between the x client and x server that have been extended properly to achieve the graphic output of the program running in the remote computer in the electronic graphic device, the electronic graphic device's video display is not limited to a computer graphic monitor could be any graphical device use for video display with any resolution.
b) direct communication of the program running in the remote server with the x client to any application programming interface implemented in the device running x server. This application programming interface couldn't be implement in the remote server with x client and using this feature allows the program to use application programming interfaces that are not supported by the remote computer running the x client.

3. The invention is a programming functionality extension of the x windows system, said x windows systems as a protocol that supports the implementation of network-based windows systems like for example x protocol.
